(19) United States
(12) Patent Application Publication
(10) Pub. No.: US 2015/0116244 A1
(43) Pub. Date: Apr. 30, 2015

(54) DISPLAY DEVICE, ELECTRONIC DEVICE, AND STORAGE MEDIUM

(71) Applicant: KYOCERA Document Solutions Inc., Osaka (JP)

(72) Inventor: Norie FUJIMOTO, Osaka (JP)

(73) Assignee: KYOCERA Document Solutions Inc., Osaka (JP)

(21) Appl. No.: 14/524,109

(22) Filed: Oct. 27, 2014

(30) Foreign Application Priority Data
Oct. 29, 2013 (JP) 2013-224288

(51) Int. Cl. G06F 3/041

(52) U.S. Cl. CPC G06F 3/0412
USPC 345/173

(57) ABSTRACT

A display device includes a display section, a detection section, a first display control section, and a second display control section. The display section has a display surface and displays a first window. The detection section detects a touch operation to the display surface of the display section. The first display control section causes the display section to form a sub region in a first window according to a touch operation detected within the first window. The second display control section causes the display section to display in the sub region description information part corresponding to a location of the sub region out of description information that a second window includes.

### INCORPORATION BY REFERENCE

The present application claims priority under 35 U.S.C. §119 to Japanese Patent Application No. 2013-224288, filed Oct. 29, 2013. The contents of this application are incorporated herein by reference in their entirety.

### BACKGROUND

The present disclosure relates to display devices that display windows, electronic devices, and storage media.

Certain information display devices include a screen divided into two display regions. One of the display regions displays a parent screen at a higher hierarchy level. The other display region displays a child screen at a lower hierarchy level. The parent and child screens are displayed side by side. In other words, the two screens (two windows) are displayed side by side.

### SUMMARY

According to the first aspect of the present disclosure, a display device includes a display section, a detection section, a first display control section, and a second display control section. The display section has a display surface and is configured to display a first window. The detection section is configured to detect a touch operation to the display surface of the display section. The first display control section is configured to cause the display section to form a sub region in the first window according to the touch operation detected within the first window. The second display control section is configured to cause the display section to display in the sub region description information part corresponding to a location of the sub region out of description information that a second window includes.

According to the second aspect of the present disclosure, an electronic device includes a display device according to the first aspect of the present disclosure and an information processing section. The information processing section is configured to execute information processing according to information input through the display device.

According to the third aspect of the present disclosure, a non-transitory computer readable storage medium stores a computer program. The computer program causes a computer to execute a process including: causing a display section to display a first window; obtaining information on a touch operation to a display surface of the display section; causing the display section to form a sub region in the first window according to the touch operation; and causing the display section to display in the sub region description information part corresponding to a location of the sub region out of description information that a second window includes.

### BRIEF DESCRIPTION OF THE DRAWINGS

FIG. 1 is a block diagram showing a configuration of a display device according to the first embodiment of the present disclosure.

FIGS. 2A and 2B are illustrations explaining control to display a sub region that the display device executes in the first embodiment of the present disclosure.

FIG. 3 is a flowchart depicting a display control method that a controller of the display device executes in the first embodiment of the present disclosure.

FIG. 4 is an illustration explaining control to move the sub region that the display device executes in the first embodiment of the present disclosure.

FIGS. 5A and 5B are illustrations explaining processing control in the sub region that the display device executes in the first embodiment of the present disclosure.

FIGS. 6A and 6B are illustrations explaining control to display the sub region that the display device executes in the second embodiment of the present disclosure.

FIG. 7 is a flowchart depicting a display control method that the controller of the display device executes in the second embodiment of the present disclosure.

FIGS. 8A and 8B are illustrations explaining control to display the sub region that the display device executes in the third embodiment of the present disclosure.

FIG. 9 is a flowchart depicting a display control method that the controller of the display device executes in the third embodiment of the present disclosure.

FIG. 10 is a block diagram showing the configuration of an image forming apparatus according to the fourth embodiment of the present disclosure.

FIG. 11 is a schematic cross sectional view explaining the image forming apparatus according to the fourth embodiment of the present disclosure.

### DETAILED DESCRIPTION

Embodiments of the present disclosure will be described below with reference to the accompanying drawings. Note that the same or corresponding elements are denoted by the same reference signs in the figures, and a description of such an element is not repeated.

### First Embodiment

### Basic Principle

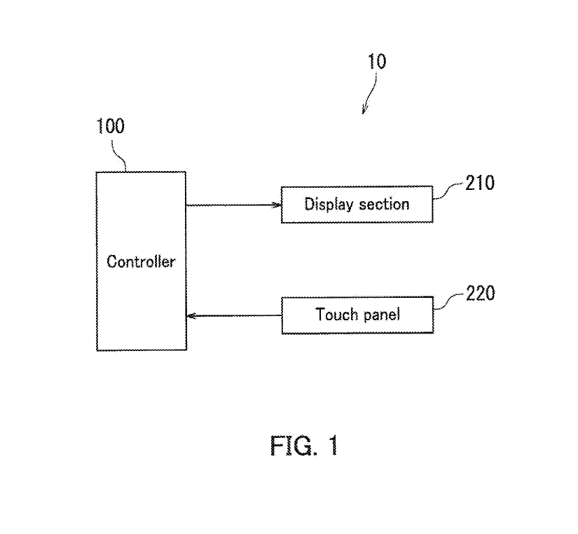

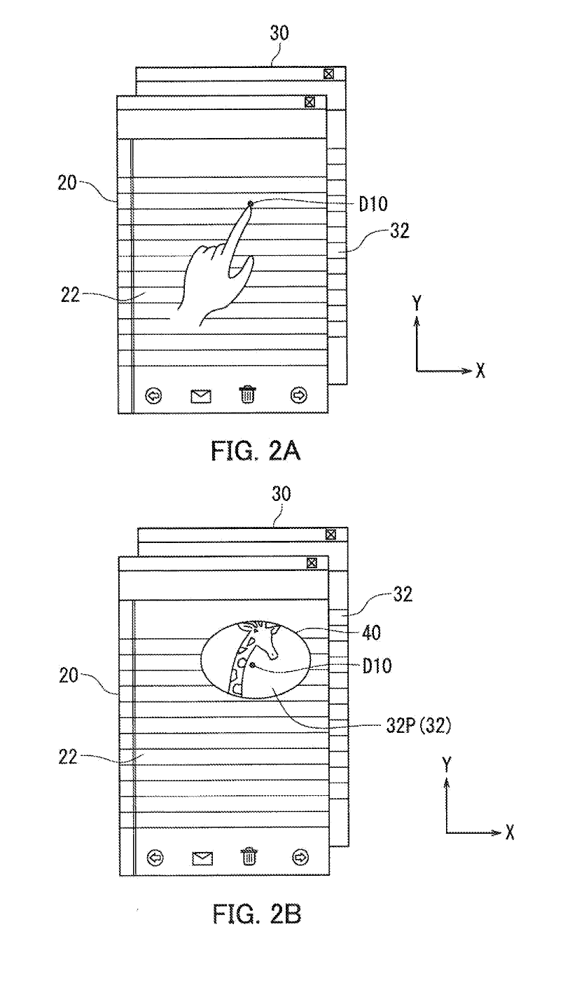

A description will be given of the basic principle of a display device 10 according to the first embodiment of the present disclosure with reference to FIGS. 1, 2A, and 2B. FIG. 1 is a block diagram showing the configuration of the display device 10. FIGS. 2A and 2B are illustrations explaining control to display a sub region 40 that the display device 10 executes. The display device 10 includes a controller 100, a display section 210, and a touch panel 220 as a detection section. The controller 100 in the first embodiment is a computer.

The display section 210 includes a display surface and displays a first window 20. The touch panel 220 detects a touch operation to the display surface of the display section 210 (see FIG. 2A). The controller 100 serving as a first display control section causes the display section 210 to form a sub region 40 in the first window 20 according to the touch operation detected within the first window 20 (see FIG. 2B). The controller 100 serving as a second display control section causes the display section 210 to display in the sub region 40 part of description information 32 corresponding to the location of the sub region 40 out of the description information 32 that the second window 30 includes. Hereinafter, the part of description information 32 corresponding to the location of the sub region 40 may be referred to as description information part 32P.

In response to the touch operation, in the first embodiment, the sub region 40 is formed in the first window 20, and description information part 32P that the second window 30 includes is displayed in the sub region 40. Accordingly, even when the second window 30 is unviewable, a user can view the description information part 32P that the second window 30 includes in addition to the first window 20 by his/her touch operation within the first window 20. As a result, viewability of the plural windows (first and second windows 20 and 30) can be prevented from being impaired. Also, window switching can be eliminated, thereby saving user's inconvenience.

The entire region of the second window 30 may be arranged behind the first window 20. Alternatively, a partial region of the second window 30 may be arranged behind the first window 20. Further, the entire or partial region of the second window 30 may be arranged outside the display surface of the display section 210.

[Display Control Method]

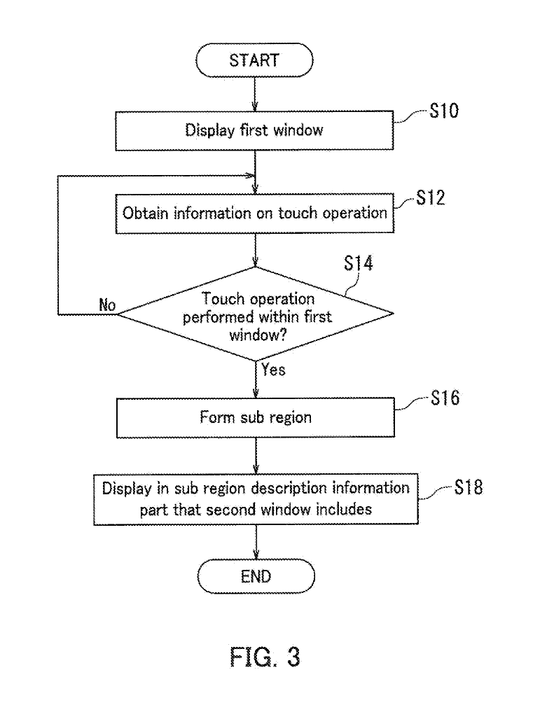

With reference to FIGS. 1-3, a description will be given of a display control method that the controller 100 executes in the first embodiment. FIG. 3 is a flowchart depicting the display control method. The controller 100 executes a computer program to execute a process of Steps S10-S18.

At Step S10, the controller 100 causes the display section 210 to display the first window 20. At Step S12, the controller 100 obtains information on a touch operation to the display surface of the display section 210 through the touch panel 220. At Step S14, the controller 100 determines whether or not the touch operation is performed within the first window 20.

When a negative determination is made (No) at Step S14, the routine returns to Step S12. When a positive determination is made (Yes) at Step S14, the routine proceeds to Step S16.

At Step S16, the controller 100 causes the display section 210 to form the sub region 40 in the first window 20 according to the touch operation. At Step S18, the controller 100 causes the display section 210 to display in the sub region 40 description information part 32P corresponding to the location of the sub region 40 out of the description information 32 that the second window 30 includes.

[Control on First Window 20 and Second Window 30]

Control on the first and second windows 20 and 30 will be described with reference to FIGS. 1, 2A, and 2B. In FIGS. 2A and 2B, the X and Y axes are parallel to the short and long sides of the display surface of the display section 210, respectively. The controller 100 manages the first and second windows 20 and 30 through first and second layers, respectively.

Description information 22 to be displayed in the first window 20, position information of the description information 22 that the first window 20 includes, arrangement information of the first window 20, and size information of the first window 20 are associated with one another in the first layer. The description information 32 to be displayed in the second window 30, position information of the description information 32 that the second window 30 includes, arrangement information of the second window 30, and size information of the second window 30 are associated with one another in the second layer.

By referencing the first layer, the controller 100 causes the display section 210 to display the first window 20 as an active window. As a result, the first window 20 having a size according to the size information in the first layer is displayed at a position according to the arrangement information in the first layer. In the first window 20, the description information 22 is displayed according to the position information of the description information 22 in the first layer.

By contrast, the second window 30 is an inactive window. The controller 100 causes the display section 210 to display the second window 30 by referencing the second layer. Specifically, the controller 100 calculates a region (non-overlapped region) of the second window 30 that is not overlapped with the first window 20 based on the arrangement information and the size information in the second layer.

The controller 100 then determines description information part corresponding to the location of the non-overlapped region out of the description information 32 based on the position information of the description information 32 in the second layer. The controller 100 causes the display section 210 to display the non-overlapped region of the second window 30 by referencing the first and second layers. As a result, the description information part corresponding to the location of the non-overlapped region is displayed in the second window 30.

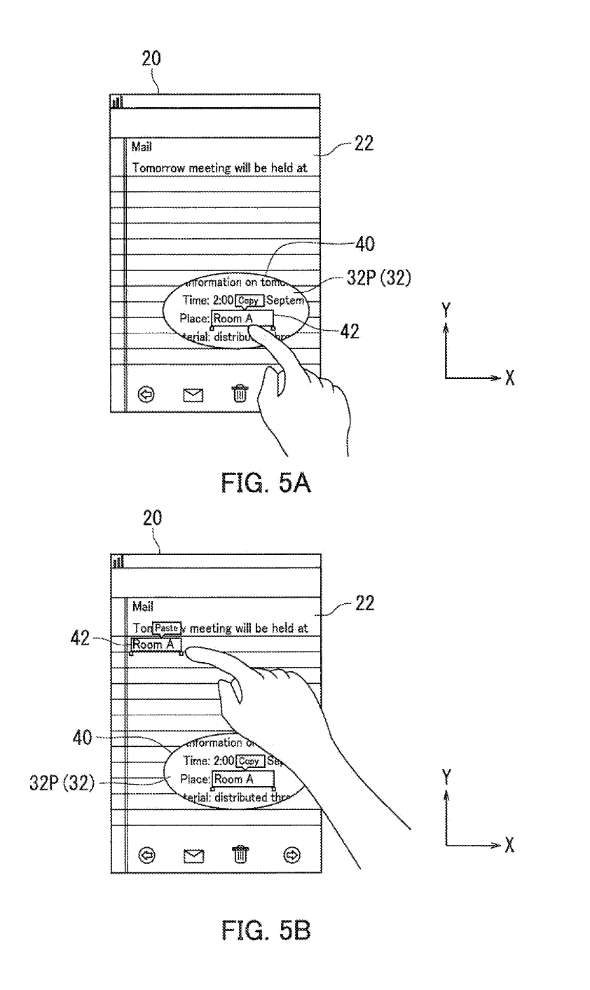

The active window refers to an operable window under the condition that a plurality of windows are displayable. The non-active window refers to a non-target window for operation under the condition that a plurality of windows are displayable. However, the second window 30 in the first embodiment is operable through the sub region 40, as will be shown in FIGS. 5A and 5B.

Further, each description information 22 and 32 is information that a user can view, such as characters, numerals, signs, figures, pictures, photographs, texts, or images, for example.

[Details of Control to Display Sub Region 40]

Control to display the sub region 40 will be described in detail with reference to FIGS. 1, 2A, and 2B. The touch panel 220 detects a touch point to the display surface of the display section 210 as a touch operation. The touch point in the first embodiment is a touch point by a user's finger. The touch operation may be moving the touch point or allowing the touch point to still. The controller 100 determines a sub region 40 forming position according to the touch operation detected within the first window 20.

The controller 100 determines, based on the position information of the description information 32 in the second layer, description information part 32P corresponding to the sub region forming position and the size of the sub region 40 out of the description information 32 in the second layer.

The controller 100 causes the display section 210 to form the sub region 40 at the determined sub region forming position and display the determined description information part 32P in the sub region 40.

Respective examples of the touch operation and the sub region 40 will be described next. A user operates the touch panel 220 with his/her single finger. In response, the touch panel 220 detects a single touch point.

When the touch panel 220 detects the touch point stilling for a first prescribed time period or longer (touch operation) at a point D10 within the first window 20 (see FIG. 2A), the controller 100 accordingly causes the display section 210 to form an oval sub region 40 having a center at the point D10 (see FIG. 2B). The shape and size of the sub region 40 are fixed.

The touch operation to form the sub region 40 is not limited to the touch operation through a single touch point and may be a touch operation through plural touch points. For example, when the touch panel 220 detects two touch points stilling for the first prescribed time period or longer within the first window 20 (touch operation), the controller 100 may cause the display section 210 to form an oval sub region 40 having centers at the two touch points. The shape and size of the sub region 40 are fixed.

Alternatively, the touch operation to form the sub region 40 can be set optionally. For example, the sub region 40 may be formed by moving a touch point along a prescribed track. The prescribed track may be a circle or a polygon, for example.

Alternatively, a given movement of a touch point may cause the sub region 40 to be formed. For example, the given movement may be a zigzag movement of a single touch point (the second embodiment that will be described later) or movements of two touch points in different directions (the third embodiment that will be described later).

Further, the shape of the sub region 40 may be a fixed shape or a shape corresponding to the touch operation. In addition, the size of the sub region 40 may be a fixed size or a size corresponding to the touch operation.

Alternatively, the controller 100 may fix the forming position, size, or shape of the sub region 40, or a combination of any two or more of them in response to the event that the touch panel 220 detects a loss of the touch point after formation of the sub region 40. This can enable a user to easily fix the forming position, size, and/or shape of the sub region 40 by removing his/her finger from the touch panel 220.

[Movement of Sub Region 40]

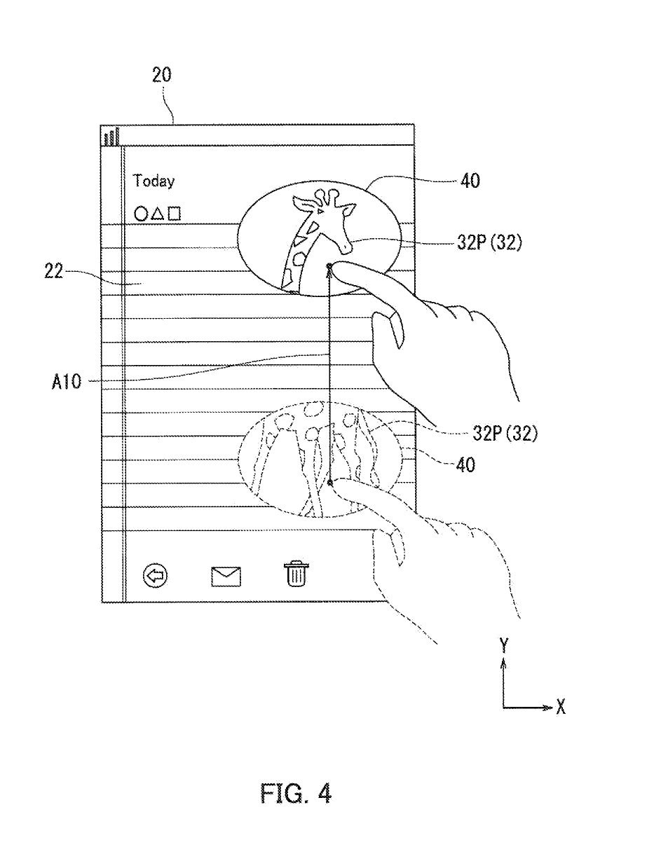

Movement of the sub region 40 will be described with reference to FIGS. 1 and 4. FIG. 4 is an illustration explaining control to move the sub region 40 that the display device 10 executes. FIG. 4 shows an example in which the entire region of the second window 30 is arranged behind the first window 20. When the touch panel 220 detects a touch operation within the sub region 40, the controller 100 serving as the first display control section accordingly causes the display section 210 to move the sub region 40 in the first window 20. The controller 100 serving as the second display control section causes the display section 210 to change the displayed content of the sub region 40 as the sub region 40 is moved.

A specific process is as follows. When the touch panel 220 detects a moving touch point after detecting the touch point stilling for a second prescribed time period or longer within the sub region 40 (touch operation), the controller 100 serving as the first display control section accordingly causes the display section 210 to move the sub region 40 in the first window 20 correspondingly to the track of the moving touch point (e.g., track indicated by an arrow A10).

Further, the controller 100 causes the display section 210 to display in the sub region 40 description information part 32P corresponding to the location of the sub region 40 being moved out of the description information 32 that the second window 30 includes. Accordingly, the description information part 32P displayed in the sub region 40 changes correspondingly to the location of the sub region 40 being moved.

The touch operation to move the sub region 40 is not limited to the touch operation through a single touch point and may be a touch operation through plural touch points. Further, the touch operation to move the sub region 40 can be set optionally.

[Processing in Sub Region 40]

An operation in the sub region 40 will be described with reference to FIGS. 1, 5A, and 5B. FIGS. 5A and 5B are illustrations explaining processing control in the sub region 40 that the display device 10 executes. FIGS. 5A and 5B each show an example in which the entire region of the second window 30 is arranged behind the first window 20. When the touch panel 220 detects a touch operation within the sub region 40, the controller 100 serving as a processing section accordingly processes description information part 32P displayed in the sub region 40.

An example of processing on the description information part 32P will be described next. As shown in FIG. 5A, the controller 100 selects a character string 42 in the description information part 32P displayed in the sub region 40 according to a movement of the touch point that the touch panel 220 detects, and copies the character string 42.

As shown in FIG. 5B, when the touch panel 220 detects a movement of the touch point from the sub region 40 to the first window 20, the controller 100 accordingly moves the copied character string 42 from the sub region 40 to the first window 20. When the touch panel 220 then detects stilling and loss of the touch point, the controller 100 accordingly pastes the copied character string 42 on the first window 20.

The processing on the description information part 32P in the sub region 40 is not limited to copy and paste. For example, the description information part 32P may be moved from the sub region 40 to the first window 20 (cut and paste). Alternatively, any description information part 22 in the first window 20 may be copied and pasted or moved (cut and paste) to the sub region 40 according to a touch operation, for example. Pasting on and movement to the sub region 40 corresponds to processing on the description information part 32P displayed in the sub region 40.

As described so far with reference to FIGS. 1-5B, in the first embodiment, the sub region 40 is formed in the first window 20 (active window) in response to the touch operation, and then, the description information part 32P that the second window 30 (inactive window) includes is displayed in the sub region 40. Accordingly, even when the second window 30 is unviewable, a user can simultaneously view the first window 20 and the description information part 32P that the second window 30 includes by his/her touch operation within the first window 20.

As a result, viewability of the first and second windows 20 and 30 can be prevented from being impaired. Also, a switching operation from the inactive window to the active window can be eliminated to reduce the number of steps for the operation, thereby saving user's inconvenience.

Furthermore, as described with reference to FIGS. 1 and 4, the sub region 40 is moved and the content displayed in the sub region 40 is changed according to the touch operation in the first embodiment. Thus, by moving the sub region 40 as necessary, a user can cause any desired description information part 32P to be displayed out of the description information 32 that the second window 30 includes.

Moreover, as described with reference to FIGS. 1, 2A, 2B, and 4, in the first embodiment, when specifying at least one of the position, size, and shape of the sub region 40, a user can view the description information 32 that the second window 30 includes, thereby achieving flexible access according to an in-use state.

Still further, as described with reference to FIGS. 1, 5A, and 5B, in the first embodiment, the description information part 32P displayed in the sub region 40 is processed in response to the event that the touch operation is detected within the sub region 40. Accordingly, the description information 32 that the second window 30 includes can be processed without need of an operation to activate the second window 30. In other words, a user can straightforwardly operate the second window 30 in an inactive state. Thus, a burden on the user can be reduced.

### Second Embodiment

### Scratch Operation

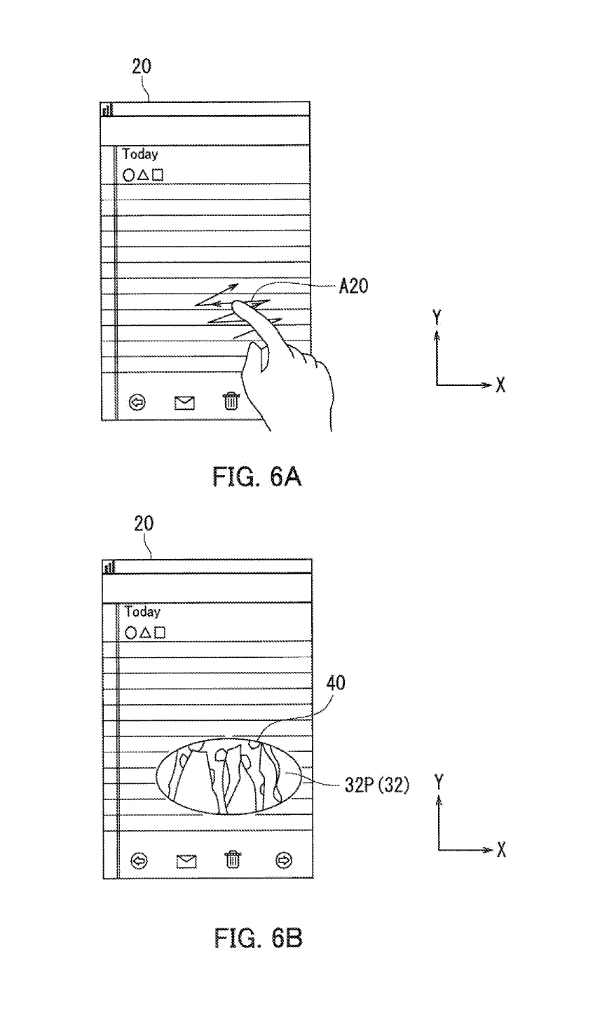

A description will be given of a display device 10 according to the second embodiment of the present disclosure with reference to FIGS. 1, 6A, and 6B. The display device 10 according to the second embodiment has the same configuration as the display device 10 shown in FIG. 1. The touch panel 220 detects a movement of a touch point to the display surface of the display section 210 as a touch operation. In the second embodiment, a user operates the touch panel 220 with his/her single finger, for example. In response, the touch panel 220 detects a single touch point.

When the touch panel 220 detects the touch point moving while changing the movement direction within the first window 20, the controller 100 serving as the first display control section accordingly causes the display section 210 to form the sub region 40 in the first window 20. A specific example will be described below.

FIGS. 6A and 6B are illustrations explaining control to display the sub region 40 that the display device 10 executes. FIGS. 6A and 6B each show an example in which the entire region of the second window 30 is arranged behind the first window 20.

As shown in FIG. 6A, the touch panel 220 detects within the first window 20 a scratch operation (e.g., scratch operation indicated by the arrow A20), that is, a touch point moving in a zigzag manner. As shown in FIG. 6B, in response to the event that the touch panel 220 detects the scratch operation, the controller 100 causes the display section 210 to form the sub region 40 in the first window 20 and display in the sub region 40 description information part 32P that the second window 30 includes.

For example, the controller 100 determines forming position and contour of the sub region 40 based on the track of the moving touch point (see the arrow A20). The controller 100 then causes the display section 210 to form the sub region 40 in the first window 20 based on the determined forming position and contour.

[Display Control Method]

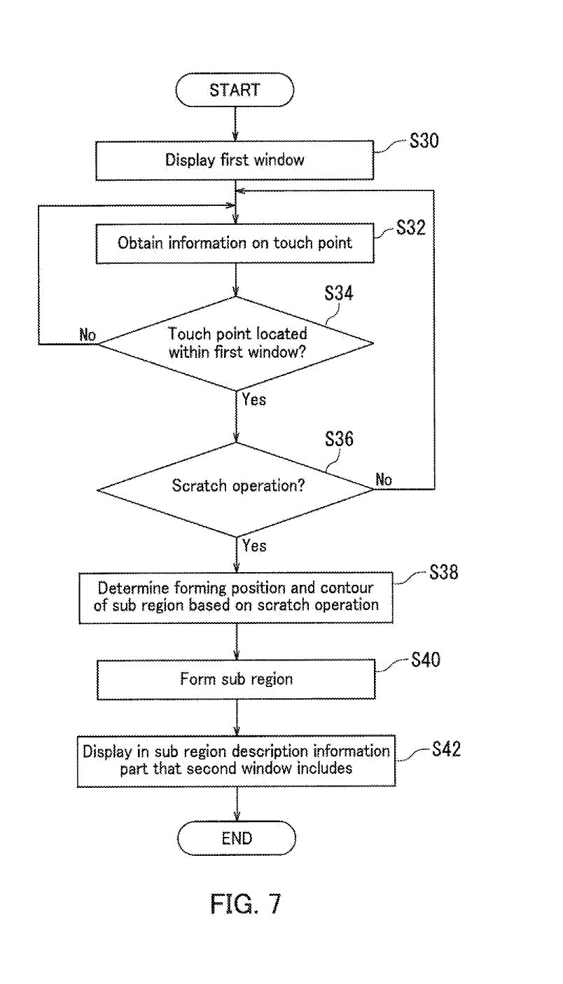

With reference to FIGS. 1, 6A, 6B, and 7, a description will be given of a display control method that the controller 100 executes in the second embodiment. FIG. 7 is a flowchart depicting the display control method. The controller 100 executes a computer program to execute a process of Steps S30-S42.

At Step S30, the controller 100 causes the display section 210 to display the first window 20. At Step S32, the controller 100 obtains information on a touch point to the display surface of the display section 210 through the touch panel 220. At Step S34, the controller 100 determines whether or not the touch point is located within the first window 20.

When a negative determination is made (No) at Step S34, the routine returns to Step S32. When a positive determination is made (Yes) at Step S34, the routine proceeds to Step S36.

At Step S36, the controller 100 determines whether or not the touch point moves in a zigzag manner, that is, whether or not the movement of the touch point presents the scratch operation. When a positive determination is made (Yes) at Step S36, the routine proceeds to Step S38. When a negative determination is made (No) at Step S36, the routine returns to Step S32.

At Step S38, the controller 100 determines forming position and contour of the sub region 40 based on the scratch operation. At Step S40, the controller 100 causes the display section 210 to form the sub region 40 in the first window 20 based on the forming position and contour determined at Step S38. At Step S42, the controller 100 causes the display section 210 to display in the sub region 40 description information part 32P corresponding to the location of the sub region 40 out of the description information 32 that the second window 30 includes.

As described with reference to FIGS. 1, 6A, 6B, and 7, the sub region 40 is formed in the first window 20 in response to the event that the touch panel 220 detects a touch point moving while changing its movement direction within the first window 20. Thus, repetitive zigzag movement (repetitive scratching) with user's finger within the first window can form the sub region 40. As a result, the user's simple operation can form the sub region 40 to enable the user to easily view the description information 32 that the second window 30 includes. Besides, the second embodiment can bring the same advantages as the first embodiment.

### Third Embodiment

### Pinch Operation

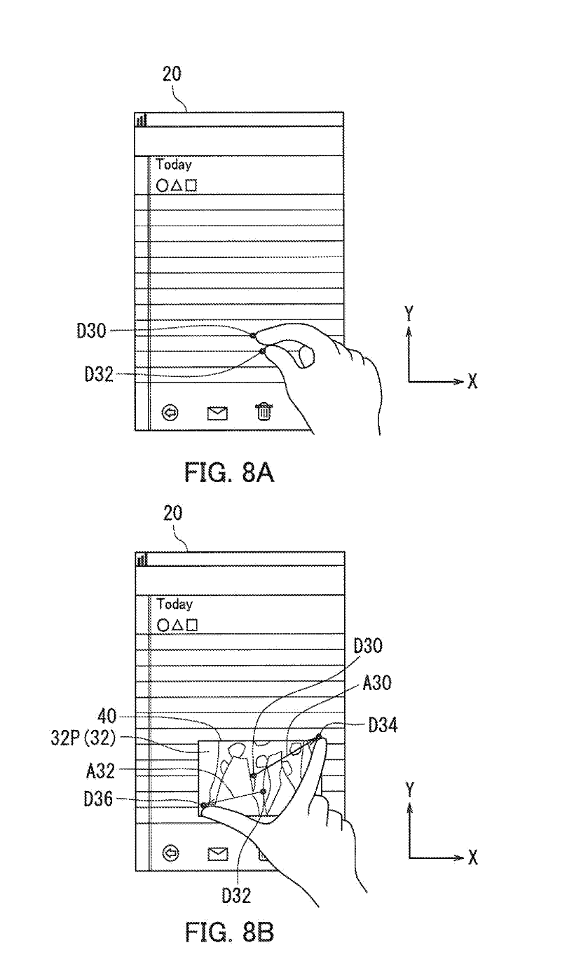

A description will be given of a display device 10 according to the third embodiment of the present disclosure with reference to FIGS. 1, 8A, and 8B. The display device 10 according to the third embodiment has the same configuration as the display device 10 shown in FIG. 1. The touch panel 220 detects movements of a plurality of touch points to the display surface of the display section 210 as a touch operation.

In the third embodiment, a user operates the touch panel 220 with his/her two fingers, for example. In response, the touch panel 220 detects two touch points.

When the touch panel 220 detects the touch points moving in different directions (e.g., pinch out or pinch in operation) within the first window 20, the controller 100 serving as the first display control section accordingly causes the display section 210 to form the sub region 40 in the first window 20. A specific example (pinch out operation) will be described below.

FIGS. 8A and 8B are illustrations explaining control to display the sub region 40 that the display device 10 executes. FIGS. 8A and 8B each show an example in which the entire region of the second window 30 is arranged behind the first window 20.

As shown in FIG. 8A, the touch panel 220 detects the touch points at points D30 and D32 within the first window 20. Then, as shown in FIG. 8B, the touch panel 220 detects a pinch out operation, that is, the two touch points moving away from each other. For example, the touch panel 220 detects the event that one of the touch points moves from the point D30 to the point D34 (arrow A30), while the other touch point moves from the point D32 to the point D36 (arrow A32).

When the touch panel 220 detects the pinch out operation, the controller 100 accordingly causes the display section 210 to form the sub region 40 in the first window 20 and display in the sub region 40 description information part 32P in the second window 30.

For example, the controller 100 determines a sub region forming position based on the points D30 or D32 where the pinch out operation starts, and determines a contour (lengths of long and short sides) of the sub region 40 based on the touch points. The shape of the sub region 40 is a rectangle having a diagonal that is a straight line connecting the two touch points. Two sides of the sub region 40 extend along the Y axis, while the other two sides thereof extend along the X axis.

The controller 100 then causes the display section 210 to form the sub region 40 in the first window 20 based on the determined forming position and contour. Assuming that the end points of the pinch out operation are the points D34 and D36, the sub region 40 having the contour determined based on the points D34 and D36 is displayed in the end.

The size and/or shape of the sub region 40 may be changed after formation of the sub region 40. For example, the size and/or shape of the sub region 40 may be changed (zoom in/out and/or shape change of sub region 40) in response to the event that the touch panel 220 detects a plurality of touch points within or on sides of the sub region 40 and detects the touch points moving in different directions.

[Display Control Method]

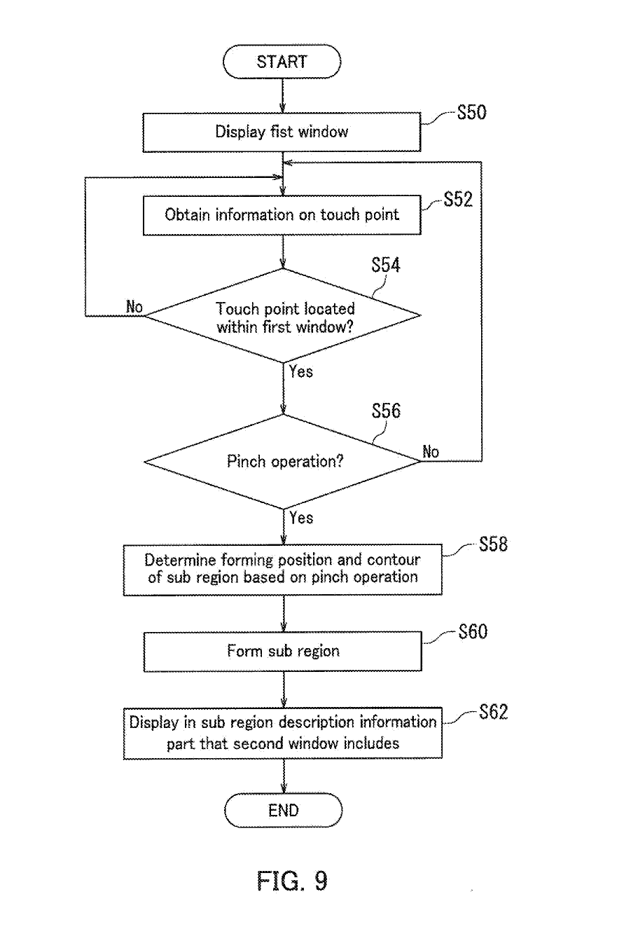

With reference to FIGS. 1, 8A, 8B, and 9, a description will be given of a display control method that the controller 100 executes in the third embodiment. FIG. 9 is a flowchart depicting the display control method. The controller 100 executes a computer program to execute a process of Steps S50-S62. Steps S50-S54 are the same as Steps S30-34 in FIG. 7. Therefore, a description thereof is omitted.

At Step S56, the controller 100 determines whether or not two touch points move in different directions, that is, whether or not the movements of the touch points presents the pinch out operation. When a negative determination is made (No) at Step S56, the routine returns to Step S52. When a positive determination is made (Yes) at Step S56, the routine proceeds to Step S58.

At Step S58, the controller 100 determines forming position and contour of the sub region 40 based on the pinch out operation. At Step S60, the controller 100 causes the display section 210 to form the sub region 40 in the first window 20 according to the forming position and contour determined at Step S58. At Step S62, the controller 100 causes the display section 210 to display in the sub region 40 description information part 32P corresponding to the location of the sub region 40 out of the description information 32 that the second window 30 includes.

As described with reference to FIGS. 1, 8A, 8B, and 9, in the third embodiment, the sub region 40 is formed in the first window 20 in response to the event that the touch panel 220 detects the two touch points moving in the different directions within the first window 20. Thus, the sub region 40 can be formed by user's pinch out operation within the first window 20. As a result, the user's simple operation can form the sub region 40, thereby enabling the user to view the description information 32 that the second window 30 includes. Besides, the third embodiment can bring the same advantages as the first embodiment.

### Fourth Embodiment

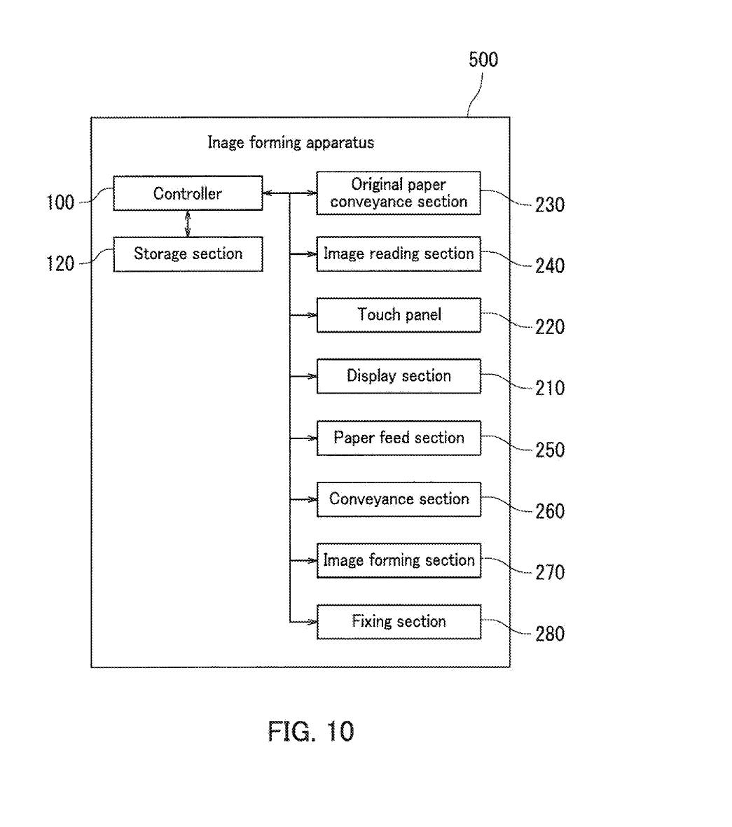

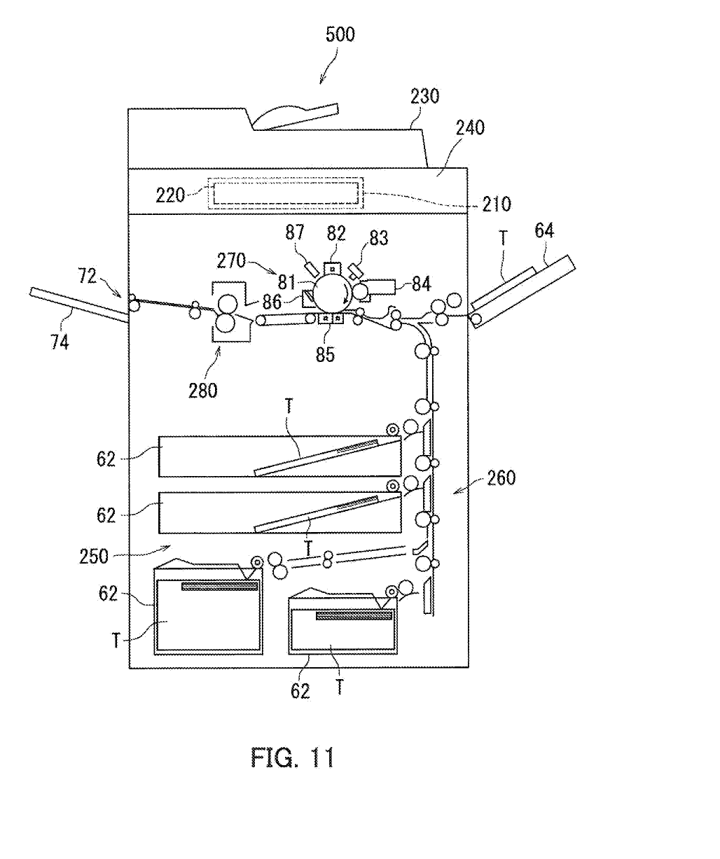

A description will be given of an image forming apparatus 500 according to the fourth embodiment of the present disclosure with reference to FIGS. 10 and 11. FIG. 10 is a block diagram showing the configuration of the image forming apparatus 500 as an electronic device. FIG. 11 is a schematic cross sectional view schematically explaining the image forming apparatus 500.

The image forming apparatus 500 includes a controller 100, a storage section 120, an original document conveyance section 230, an image reading section 240, a touch panel 220, a display section 210, a paper feed section 250, a conveyance section 260, an image forming section 270, and a fixing section 280. The storage section 120 includes a main storage device (e.g., semiconductor memory) and an auxiliary storage device (e.g., semiconductor memory or hard disc drive). The storage section 120 is an example of a storage medium.

The controller 100 controls the overall operation of the image forming apparatus 500. Specifically, the controller 100 executes computer programs stored in the storage section 120 to control the original document conveyance section 230, the image reading section 240, the touch panel 220, the display section 210, the paper feed section 250, the conveyance section 260, the image forming section, 270, and the fixing section 280. The controller 100 may be a central processing unit (CPU), for example. The touch panel 220 is arranged on the display surface of the display section 210, for example.

The controller 100 in the fourth embodiment has the function of the controller 100 in any of the first to third embodiments. Accordingly, a combination of the controller 100, the display section 210, and the touch panel 220 in the fourth embodiment corresponds to the display device 10 according to any of the first to third embodiments. The storage section 120 stores each information in the first and second layers.

The original document conveyance section 230 conveys an original document to the image reading section 240. The image reading section 240 reads an image on the original document to generate image data. The paper feed section 250 includes a paper feed cassette 62 and a manual feed tray 64. The paper feed cassette 62 receives a sheet T. The sheet T is sent to the conveyance section 260 from the paper feed cassette 62 or the manual feed tray 64. The sheet T may be plain paper, recycled paper, thin paper, thick paper, or an overhead projector (OHP) sheet, for example.

The conveyance section 260 conveys the sheet T to the image forming section 270. The image forming section 270 forms an image on the sheet T according to information input through the display device 10 (touch panel 220). The image forming section 270 includes a photosensitive drum 81, a charger 82, an exposure section 83, a development section 84, a transfer section 85, a cleaning section 86, and a static eliminating section 87. Specifically, the image forming section 270 forms (prints) the image on the sheet T in the following manner.

The charger 82 electrostatically charges the surface of the photosensitive drum 81. The exposure section 83 irradiates the surface of the photosensitive drum 81 with a light beam based on image data generated by the image reading section 240 or image data stored in the storage section 120. This forms an electrostatic latent image corresponding to the image data on the surface of the photosensitive drum 81.

The development section 84 develops the electrostatic latent image formed on the surface of the photosensitive drum 81 to form a toner image on the surface of the photosensitive drum 81. When the sheet T is supplied between the photosensitive drum 81 and the transfer section 85, the transfer section 85 transfers the toner image to the sheet T.

The sheet T to which the toner image is transferred is conveyed to the fixing section 280. The fixing section 280 fixes the toner image to the sheet T by applying heat and pressure to the sheet T. Then, an ejection roller pair 72 ejects the sheet T onto an exit tray 74. The cleaning section 86 removes toner remaining on the surface of the photosensitive drum 81. The static eliminating section 87 removes electrostatic charges remaining on the surface of the photosensitive drum 81.

As described with reference to FIGS. 10 and 11, the image forming apparatus 500 in the fourth embodiment includes the display device 10 according to any of the first to third embodiments. Accordingly, the same advantages can be brought as those in any of the first to third embodiments.

The display device 10 according to any of the first to third embodiments can be built in any electronic device besides the image forming apparatus 500. The electronic device executes information processing according to information input through the display device 10. For example, the electronic device may be a mobile terminal (e.g., smartphone) or a tablet terminal.

The first to fourth embodiments have been described so far with reference to FIGS. 1-11. Note that the above embodiments should not be taken to limit the present disclosure. The present disclosure can be reduced in practice in various manners within the scope not departing from the gist of the present disclosure. The following variations are possible, for example. In the following variations, the controller 100 serving as the first display control section controls formation of the sub region 40, while the controller 100 serving as the second control section controls display of description information part 32P in the sub region 40.

(1) As has been described with reference to FIGS. 2A, 2B, 6A, 6B, 8A and 8B, the sub region 40 is formed in the first window 20. In addition, the controller 100 serving as the second display control section may cause an additional sub region (hereafter it may be referred to as “sub sub region”) to be formed in the sub region 40 in response to the event that a touch operation is detected within the sub region 40. For example, where a third window (not shown) is arranged behind the second window 30, the controller 100 may cause the display section 210 to display in the sub sub region 40 description information part corresponding to the location of the sub sub region formed in the sub region 40 out of description information that the third window includes.

The third window is an inactive window. The controller 100 manages the third window through a third layer. The description information to be displayed in the third window, position information of the description information that the third window includes, arrangement information of the third window, and size information of the third window are associated with one another in the third layer.

The controller 100 calculates a region (non-overlapped region) of the third window that is not overlapped with the first and second windows 20 and 30 based on the arrangement information and the size information in the third layer.

The controller 100 then determines description information part in a region of the third window corresponding to the non-overlapped region out of the description information that the third window includes based on the position information of the description information in the third layer. By referencing the first to third layers, the controller 100 causes the display section 210 to display the non-overlapped region of the third window. As a result, the description information part in the region of the third window corresponding to the non-overlapped region is displayed in the third window.

The controller 100 determines a sub sub region forming position according to a touch operation detected within the sub region 40. The controller 100 determines, based on the position information of the description information in the third layer, description information part corresponding to the forming position and size of the sub sub region out of the description information that the third layer includes.

The controller 100 then causes the display section 210 to form the sub sub region at the determined forming position and display the determined description information part in the sub sub region.

(2) As has been described so far with reference to FIGS. 2A, 2B, 6A, 6B, 8A, and 8B, description information part 32P that the second window 30 includes is displayed in the sub region 40. The second window 30 may be inactive, or may be a desktop (a screen at the lowermost level in an operating system that references a GUI environment). For example, the controller 100 causes the display section 210 to display in the sub region 40 description information part (e.g., icon) corresponding to the location of the sub region 40 out of description information that the desktop includes. Where an icon to initiate an application is displayed in the sub region 40, for example, the controller 100 may initiate the application when the touch panel 220 detects a touch operation (e.g., a tap operation or a double tap operation) to the icon.

(3) As has been described with reference to FIGS. 5A and 5B, description information part 32P displayed in the sub region 40 is processed in response to the event that the touch operation is detected within the sub region 40. Alternatively, when the touch panel 220 detects a touch operation within the sub region 40, the controller 100 may accordingly cause description information part 32P to be displayed in a scrolling or zooming manner in the sub region 40.

(4) As has been described with reference to FIGS. 2A, 2B, 6A, 6B, 8A, and 8B, gestures to form the sub region 40 are discussed including stilling of a touch point for the first prescribed time period or longer, the scratch operation, and the pinch in and pinch out operations. In addition, other gestures including dragging are available. As such, a threshold value may be provide to distinguish a gesture to form the sub region 40 from the other gestures for the other operations.

The threshold value will be discussed below. As described with reference to FIGS. 6A and 6B, the sub region 40 is formed in response to the event that a touch point moving in a zigzag manner is detected. In this case, the controller 100 may cause the display section 210 to form the sub region 40 on the condition that the number of times of turnings of a touch point moving in a zigzag manner is N or larger (N is an integer larger than 1). Thus, it can be prevented that the sub region 40 is formed by a movement of the touch point against user's intention. The value of N, that is, the threshold value can be set optionally.

As described with reference to FIGS. 6A and 6B, the sub region 40 is formed in response to the event that the scratch operation is detected. In addition, the sub region 40 is formed in response to the event that the pinch out operation is detected in the third embodiment described with reference to FIGS. 8A and 8B. Additionally, the controller 100 can cause the display section 210 to form the sub region 40 in response to the event that the touch panel 220 detects a prescribed touch operation after a touch point stills for a third prescribed time period or longer. The prescribed touch operation may be a scratch operation, pinch out operation, or pinch in operation, for example. The third prescribed time period, that is, the threshold value can be set optionally.

Moreover, when a threshold value is provided for the movement of the sub region 40 described with reference to FIG. 4, the gesture to move the sub region 40 can be distinguished from the other gestures for the other operations. The second prescribed time period in the explanation of FIG. 4 serves as the threshold value.

Moreover, when a threshold value is provided for the processing in the sub region 40 described with reference to FIGS. 5A and 5B, the gesture for the processing in the sub region 40 can be distinguished from the other gestures for the other operations.

(5) As described with reference to FIGS. 8A and 8B, the pinch out operation is discussed as an example of the plural touch points moving in different directions. However, the controller 100 may cause the display section 210 to form the sub region 40 in the first window 20 in response to the event that the pinch in operation, that is, two touch points approaching each other is detected within the first window 20.

(6) As described with reference to FIGS. 8A and 68B, the sub region 40 is a rectangle in shape having a diagonal that is a straight line connecting the two touch points. In order to form the sub region 40 in response to the invent that a pinch out or pinch in operation along the Y axis is detected within the first window 20, the controller 100 may determine the length of the sub region 40 along the Y axis based on the two touch points and set the width thereof along the X axis to a given width. In reverse, in order to form the sub region 40 in response to the event that a pinch out or pinch in operation along the X axis is detected within the first window 20, the controller 100 may determine the width of the sub region 40 along the X axis based on the two touch points and set the length thereof along the Y axis to a given length.

(7) The present disclosure is applicable to fields of display devices displaying a plurality of windows and electronic devices including such a display device.

What is claimed is:

1. A display device comprising:
a display section having a display surface and configured to display a first window;
a detection section configured to detect a touch operation to the display surface of the display section;
a first display control section configured to cause the display section to form a sub region in the first window according to the touch operation detected within the first window; and
a second display control section configured to cause the display section to display in the sub region description information part corresponding to a location of the sub region out of description information that a second window includes.

2. A display device according to claim 1, wherein
the detection section detects a movement of a touch point to the display surface as the touch operation, and
when the detection section detects the touch point moving while changing a movement direction within the first window, the first display control section accordingly causes the display section to form the sub region in the first window.

3. A display device according to claim 1, wherein
the detection section detects movements of a plurality of touch points to the display surface as the touch operation, and
when the detection section detects the touch points moving in different directions within the first window, the first display control section accordingly causes the display section to form the sub region in the first window.

4. A display device according to claim 1, wherein
when the detection section detects the touch operation within the sub region, the first display control section accordingly causes the display section to move the sub region in the first window, and
the second display control section causes the display section to change a content displayed in the sub region according to the movement of the sub region.

5. A display device according to claim 1, further comprising:
a processing section configured to process the description information part displayed in the sub region in response to an event that the detection section detects the touch operation within the sub region.

6. A display device according to claim 1, wherein
when the detection section detects a touch point stilling and then moving within the sub region, the first display control section causes the display section to move the sub region along a track of the moving touch point.

7. A display device according to claim 1, wherein
the second display control section causes the display section to form an additional sub region in the sub region according to the touch operation detected within the sub region.

8. An electronic device comprising:
a display device according to claim 1; and
an information processing section configured to execute information processing according to information input through the display device.

9. An electronic device according to claim 8, wherein
the information processing section includes an image forming section configured to form an image on a sheet according to the information input through the display device.

10. A non-transitory computer readable storage medium that stores a computer program, wherein
the computer program causes a computer to execute a process including:
causing a display section to display a first window;
obtaining information on a touch operation to a display surface of the display section;
causing the display section to form a sub region in the first window according to the touch operation; and
causing the display section to display in the sub region description information part corresponding to a location of the sub region out of description information that a second window includes.
